(19) United States
(12) Patent Application Publication
(10) Pub. No.: US 2026/0028265 A1
(43) Pub. Date: Jan. 29, 2026

(54) METHODS OF MAKING HOLLOW CORE OPTICAL FIBERS

(71) Applicant: CORNING INCORPORATED, CORNING, NY (US)

(72) Inventors: Chams Baker, Corning, NY (US); Antoine Gaston Denis Bisson, Painted Post, NY (US)

(21) Appl. No.: 19/269,592

(22) Filed: Jul. 15, 2025

Related U.S. Application Data
(60) Provisional application No. 63/676,496, filed on Jul. 29, 2024.

(51) Int. Cl. C03B 37/025; G02B 6/02

(52) U.S. Cl. CPC C03B 37/0256; C03B 37/0253; G02B 6/02328; C03B 2203/16; C03B 2203/42

(57) ABSTRACT

A method of manufacturing a hollow core optical fiber from a hollow core optical fiber preform is disclosed, the method including measuring a first dimension of the hollow core optical fiber while drawing the hollow core optical fiber from the hollow core optical fiber preform, comparing the measured first dimension with a predetermined target range, and adjusting a first preform property of the hollow core optical fiber preform if the measured first dimension is outside of the predetermined target range while drawing the hollow core optical fiber from the hollow core optical fiber preform.

This application claims the benefit of priority to U.S. Provisional Patent Application No. 63/676,496 filed on Jul. 29, 2024, the content of which is relied upon and incorporated herein by reference in its entirety.

### FIELD OF THE DISCLOSURE

The present disclosure is generally directed to methods of making hollow core optical fibers, and more specifically to methods of making hollow core optical fibers using real-time feedback control.

### BACKGROUND OF THE DISCLOSURE

Anti-resonant hollow core optical fibers are traditionally comprised of a hollow, outer cladding inside of which a plurality of structural tubes are arranged. The structural tubes have a smaller diameter and thickness than the outer cladding. Each structural tube is bonded to an inner surface of the outer cladding such that the structural tubes are arranged about the inner circumference of the outer cladding. Furthermore, each structural tube runs parallel to a length of the outer cladding. A central portion of the outer cladding, around which the structural tubes are arranged, remains empty as an air-filled void. The resulting anti-resonant fiber guides light through the empty-central portion of the core. Such anti-resonant fibers are able to provide reduced optical loss of signal.

The structural tubes must have specific dimensions in order to transmit the optical signal within the air-filled void formed by the outer cladding. If the structural tubes are not made with such specific dimensions, the structural tubes will not act as anti-resonant members at a predetermined wavelength. However, producing structural tubes with precise dimensions in hollow core optical fibers is extremely difficult.

### SUMMARY OF THE DISCLOSURE

An exemplary approach to solve the object is described by the independent claims. Various embodiments are defined with the dependent claims.

The present disclosure is directed to a hollow core optical fiber and methods of making thereof. According to aspects of the present disclosure, hollow core optical fibers are manufactured to have precise dimensions using active pressure control during the manufacturing process. More specifically, in embodiments, the pressure within a preform is actively measured and controlled during the drawing of a hollow core optical fiber in order to adjust the dimensions in the drawn fiber in real time.

According to aspects of the present disclosure, a method of manufacturing a hollow core optical fiber from a hollow core optical fiber preform is disclosed, the method comprising measuring a first dimension of the hollow core optical fiber while drawing the hollow core optical fiber from the hollow core optical fiber preform, comparing the measured first dimension with a predetermined target range, and adjusting a first preform property of the hollow core optical fiber preform if the measured first dimension is outside of the predetermined target range while drawing the hollow core optical fiber from the hollow core optical fiber preform.

Although many different embodiments are listed, the embodiments may exist individually or in any combination as possible. Hereinafter exemplary embodiments are shown and described.

### BRIEF DESCRIPTION OF THE DRAWINGS

FIG. 1A illustrates a cross-sectional view of an exemplary hollow core optical fiber, according to embodiments of the present disclosure;

FIG. 1B illustrates a cross-sectional view of another exemplary hollow core optical fiber, according to embodiments of the present disclosure;

FIG. 1C illustrates an enlarged view of a portion of the exemplary hollow core optical fiber of FIG. 1A, according to embodiments of the present disclosure;

FIG. 2 illustrates a process for producing a hollow core optical fiber, according to embodiments of the present disclosure;

FIG. 3 illustrates a cross-sectional view of an exemplary hollow core optical fiber preform, according to embodiments of the present disclosure;

FIG. 4 illustrates a fiber drawing system, according to embodiments of the present disclosure;

FIG. 5 illustrates the more detailed steps of the process of FIG. 2, according to embodiments of the present disclosure; and

FIG. 6 also illustrates the more detailed steps of the process of FIG. 2, according to embodiments of the present disclosure;

FIG. 7A illustrates an interference spectrum plot in which power spectral density is plotted as a function of wavelength; and

FIG. 7B illustrates a Fourier transform plot of the interference spectrum plot of FIG. 7A.

### DETAILED DESCRIPTION

Additional features and advantages of the disclosure will be set forth in the detailed description which follows and will be apparent to those skilled in the art from the description or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

It is also important to note that the construction and arrangement of the elements of the disclosure, as shown in the exemplary embodiments, is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel and nonobvious teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present disclosure. Other substitutions, modifications, changes, and omissions may be made in the design, operating conditions, and arrangement of the desired and other exemplary embodiments without departing from the spirit of the present disclosure.

Reference will now be made in detail to the present preferred embodiments of the disclosure, examples of which are illustrated in the accompanying drawings. Whenever possible, the same reference numbers will be used throughout the drawings to refer to the same or like parts.

As is known in the art, the behavior of gas is dictated by gas law such as the ideal gas law: PV=nRT, where P is the pressure of the gas, V is the volume of the gas, n is the number of moles of the gas, R is the ideal gas constant, and T is the temperature of the gas. The ideal gas law shows the relationship between temperature, pressure, volume, and number of moles of a gas. Aspects of the present disclosure utilize these relationships to efficiently produce hollow core optical fibers with specific dimensions. According to the embodiments of the present disclosure, hollow core optical fibers are produced to have specific dimensions, including specific diameter sizes. In the embodiments disclosed herein, pressure is measured and controlled in order to adjust and alter the dimensions of the hollow core optical fiber in real-time, as the hollow core fiber is being drawn.

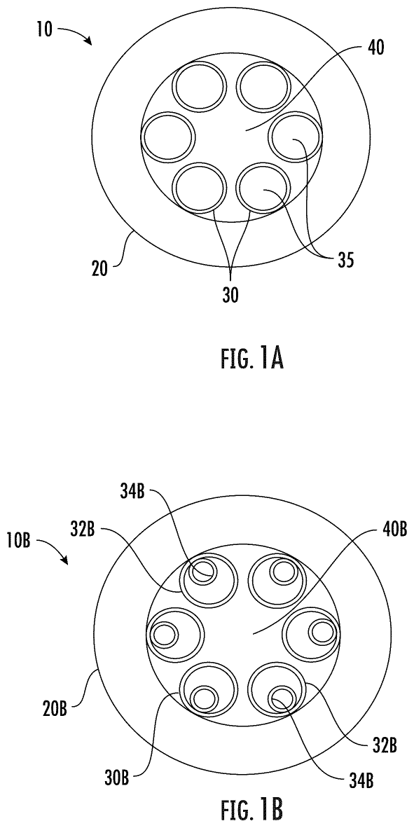

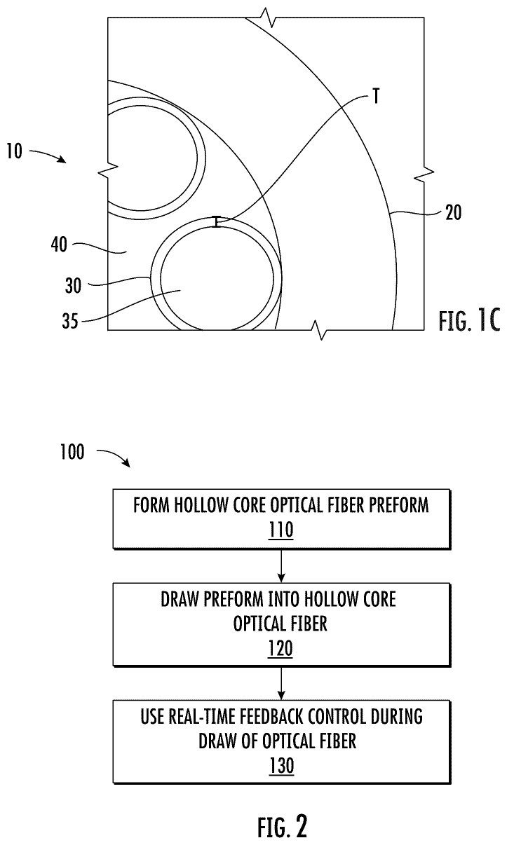

Referring now to FIG. 1A, an exemplary cross-sectional view of a hollow core optical fiber 10 is shown. Fiber 10 comprises an outer cladding 20, one or more structural tubes 30, and a hollow core 40. Structural tubes 30 are disposed radially around hollow core 40, and outer cladding 20 is disposed radially around structural tubes 30.

Outer cladding 20 is a hollow, cylindrical member formed of glass. Thus, outer cladding 20 has a hollow interior and forms a ring-like, donut shape in cross-section (as shown in FIG. 1A). In some embodiments, outer cladding 20 is formed of doped or undoped silica glass. In embodiments, outer cladding 20 consists essentially of or consists of silica-based glass. Outer cladding 20 may have a length from about 10 cm to about 2 m, or about 25 cm to about 1.5 m, or about 50 cm to about 1 m.

Structural tubes 30 are glass tubes disposed within the hollow interior of outer cladding 20. Similar to outer cladding 20, structural tubes 30 are hollow, cylindrical members formed of glass. Thus, structural tubes 30 each form a ring-like, donut shape in cross-section (as shown in FIG. 1A). In some embodiments, structural tubes 30 are formed of doped or undoped silica glass. In embodiments, structural tubes 30 consist essentially of or consist of silica-based glass. Structural tubes 30 may each have a length that extends the length (or substantially the length) of outer cladding 20. Thus, structural tubes 30 and outer cladding 20 may have the same length.

As shown in FIG. 1A, the hollow interior of each structural tube 30 forms a capillary 35 through which gas can flow, such as, for example, ambient air or nitrogen gas. As used herein, capillaries 35 are lumens formed by the walls of structural tubes 30. An outer diameter of each capillary 35 is defined by an inner diameter of each structural tube 30. A wall thickness of structural tubes 30 is carefully selected to optimize anti-resonant conditions in hollow core 40.

Hollow core 40 may be formed and defined by the outer profile of structural tubes 30. Thus, an outer surface of structural tubes 30 forms an outer diameter of hollow core 40. When in use, light is guided through the air in hollow core 40 along fiber 10. Structural tubes 30 help to maintain the light within hollow core 40. Such provides transmission of optical signals along fiber 10 with reduced transmission loss.

In some embodiments, hollow core optical fiber 10 is an anti-resonant hollow core optical fiber. As is known in the art, anti-resonant fibers are one type of hollow core fibers. There are three types of hollow core fibers. The first type is Bragg hollow core fibers in which the cladding is a Bragg structure of concentric periodic dielectric multilayers that confine light in a hollow (air) region. The second type is photonic bandgap hollow core fibers that use a two-dimensional photonic crystal structure with periodically arranged air holes that confine light in the hollow core region. The third type is anti-resonant hollow core fibers in which the fiber comprises one or more layers of thin glass structural tubes to prevent light from leaking out of the air core.

It is also noted that structural tubes 30 may be positioned in various configurations around an inner diameter of outer cladding 20. FIG. 1A shows a first embodiment in which fiber 10 comprises six structural tubes 30 evenly spaced around the inner diameter of outer cladding 20. However, fiber 10 may comprise more or less structural tubes 30. For example, fiber 10 may comprise two, three, four, five, seven, eight, nine, ten, eleven, twelve, or more structural tubes 30. Furthermore, structural tubes 30 may be evenly spaced apart from each other, or structural tubes 30 may be spaced apart inconsistently from each other. In yet some embodiments, one or more structural tubes 30 may be in contact with an adjacent structural tube 30 at a contact point. However, in general, adjacent structural tubes 30 are typically separated by a gap so as to avoid the formation of a waveguide at the contact point. More specifically, such a contact point between two structural tubes can form an increased wall thickness at the contact point (due to the additive wall thickness of the two structural tubes). The increased wall thickness forms a waveguiding region, which lowers the attenuation of the optical fiber.

FIG. 1B shows an embodiment in which fiber 10B comprises nested structural tubes 30B. More specifically, structural tubes 30B comprise an outer tube 32B (a first structural tube) and an inner tube 34B (a second structural tube) such that inner tube 34B is nested within outer tube 32B. It is also noted that fiber 10B comprises an outer cladding 20B and a hollow core 40B, similar to the embodiment of FIG. 1A. Furthermore, the present disclosure is not limited to the exemplary arrangements disclosed herein. Other embodiments and arrangements of structural tubes are also contemplated.

Each structural tube 30 may be formed to have various sizes, including various inner and outer diameters and various wall thickness values. As shown in FIG. 1C, structural tubes 30 have a wall thickness dimension T, which is defined by the inner and outer diameters of the structural tube. The size of structural tubes 30 (including the inner diameter, outer diameter, and wall thickness) affects the wavelengths at which the fiber is anti-resonant. For example, it has been found that a wall thickness of about 300 nm to about 450 nm in a hollow core optical fiber provides zero transmission through the walls of the structural tubes (so that the fiber is anti-resonant) at wavelengths from about 1200 nm to about 1600 nm. Altering the thickness of the hollow core optical fibers to be greater or less than the 300 nm to 450 nm range may then also alter the wavelength window to be greater or less than the about 1200 nm to about 1600 nm window.

Embodiments of the present disclosure are directed towards processes and methods to control the size of the structural tubes and the hollow core formed thereby, including the inner and outer diameter dimensions of the structural tubes and their wall thickness. Such dimensions also affect the size of capillaries 35 formed by structural tubes 30. The processes and methods disclosed herein to control the dimensions of hollow core optical fiber 10 are performed during the drawing of the fiber based on real-time feedback control, as discussed further below.

FIG. 2 provides an exemplary process 100 to produce hollow core optical fibers according to the embodiments disclosed herein. Process 100 may be utilized to produce hollow core optical fiber 10, as shown in FIG. 1A, 1B, or 1C, or other hollow core fibers with different configurations. Thus, process 100 is not limited to the exemplary fiber structures of FIGS. 1A through 1C.

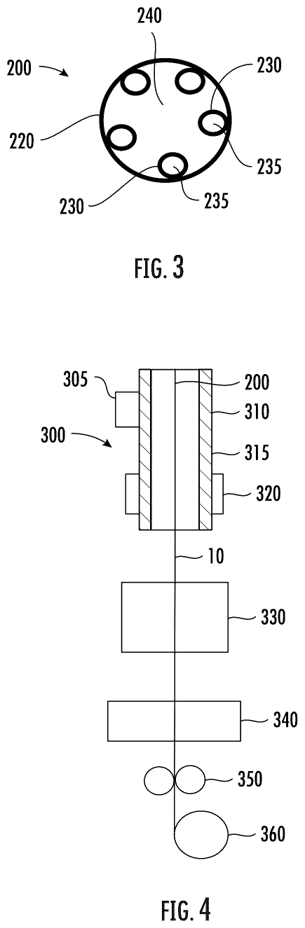

Step 110 of process 100 comprises forming a hollow core fiber preform. In some embodiments, step 110 of process 100 specifically comprises inserting one more glass tubes into a glass cladding tube to form the preform. FIG. 3 shows an exemplary embodiment of a hollow core optical fiber preform 200 comprised of glass tubes 230 inserted into a glass cladding tube 220. A hollow core 240 is formed by glass tubes 230 in preform 200. And the walls of glass tubes 230 form inner capillaries 235. Glass tubes 230 of preform 200 become structural tubes 30 in the drawn optical fiber, capillaries 235 become capillaries 35 in the drawn optical fiber, glass cladding tube 220 becomes outer cladding 20 in the drawn optical fiber, and hollow core 240 becomes hollow core 40 in the drawn optical fiber. It is noted that FIG. 3 shows an exemplary hollow core optical fiber preform 200 and that embodiments of the present disclosure, including the steps of process 100, may be used with hollow core optical fiber preforms having other configurations than those shown in FIG. 3. Reference to the specific embodiment of FIG. 3 with regard to the steps of process 100 is used for illustrative purposes only.

Furthermore, as is known in the art, the process to produce hollow core optical fiber preform 200 may include consolidation and redraw steps. For example, during consolidation, a precursor to the preform may be heated to a temperature above the sintering temperature of the glass to consolidate the glass to form hollow core optical fiber preform 200. In embodiments, the precursor is heated to a temperature from about 1400° C. to about 2000° C., or about 1500° C. to about 1900° C., or about 1600° C. to about 1800° C., or about 1675° C. to about 1800° C., or about 1800° C. to about 1950° C., or about 1700° C. to consolidate the glass.

During a redraw step, hollow core optical fiber preform 200 may be heated to a temperature above the softening point of glass and stretched into a smaller diameter preform.

At the conclusion of step 110, preform 200 may be ready for drawing into an optical fiber.

At step 120 of process 100, hollow core optical fiber preform 200 is drawn into an optical fiber (such as hollow core optical fiber 10). FIG. 4 depicts an exemplary fiber drawing system 300 that comprises a draw furnace 310 with a heating element 320 and a muffle 315. Hollow core optical fiber preform 200 is disposed vertically in draw furnace 300, and heating element 320 of draw furnace 310 applies heat to at least a bottom portion of preform 200. Optical fiber 10 (in the form of a bare, uncoated optical fiber) is then drawn from the heated preform 200.

In order to draw fiber 10, a root portion of preform 300 is pulled by a tractor 350 and wound onto a spoon or reel 360. System 300 may comprise additional components such as a monitor 330 to monitor and measure the dimensions of optical fiber 10 and/or the draw speed of optical fiber 10. In embodiments, monitor 330 monitors and measures the diameter dimensions of outer cladding 20, structural tubes 30 (including nested glass tubes such as outer tubes 32B and inner tubes 34B), and/or hollow core 40, including the inner and outer diameters of each of these components. System 300 may also comprise an adjustment mechanism 305 to measure and control/adjust one or more preform properties (such as the pressure within hollow core optical fiber preform 200). It is also noted that in embodiments, monitor 330 and/or adjustment mechanism 305 may be separate components from fiber drawing system 300. In the embodiment shown in FIG. 4, fiber drawing system 300 encompasses both monitor 330 and adjustment mechanism 305.

Additionally, as shown in FIG. 4, system 300 may further comprise a coating apparatus 340. Optical fiber 10 is a bare, uncoated fiber until reaching coating apparatus 340, which may apply a polymeric-based coating to an outside surface of the bare optical fiber. The coated fiber may then pass through a coating curing apparatus (not shown) before being wound on reel 360.

During the drawing of hollow core optical fiber preform 200 into hollow core optical fiber 10, one or more fiber properties may be controlled based upon real time feedback control. With reference again to FIG. 2, step 130 comprises using real time feedback control of one or more fiber properties during the draw of the fiber. Therefore, step 130 is performed during the draw of the fiber so that step 130 is preformed simultaneously as step 120. The real time feedback control comprises controlling one or more fiber dimensions based on the real time measurement of one or more preform properties.

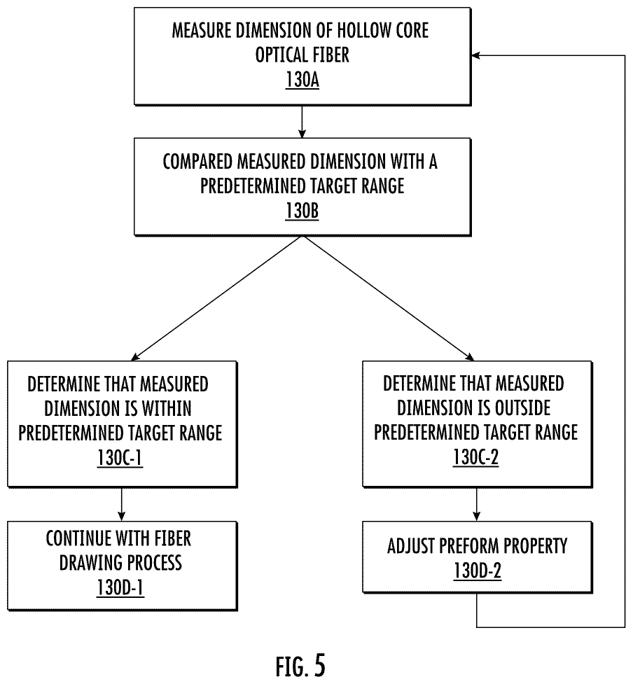

FIG. 5 shows a more detailed process of the real-time feedback control step 130 of process 100. In particular, at step 130A, a dimension of hollow core optical fiber 10 is measured. As discussed above, this dimension may be a diameter dimension such as a diameter of outer cladding 20, structural tubes 30 (including nested glass tubes such as outer tubes 32B and inner tubes 34B), and/or hollow core 40. For example, the diameter dimension may an inner diameter of one or more of these components (such as inner diameter of structural tubes 30, which corresponds to the diameter of capillaries 35). Furthermore, the dimension measured during step 130A is measured during the drawing of hollow core optical fiber 10. Monitor 330 may measure the dimension during step 130A.

At step 130B, the measured dimension is compared with a predetermined target range, which may be a specific value or a range of values. Monitor 330 may also perform this compare step. If is determined that the measured dimension is within the predetermined target range (step 130C-1), then the process continues with the fiber drawing process (step 130D-1). However if it determined that the measured dimension is outside of the predetermined target value range (step 130C-2), by being either above or below the range, then one or more preform properties are adjusted (step 130D-2). In embodiments, the preform property is at least the pressure within preform 200 (such as the pressure of the gas within glass cladding tube 220, glass tubes 230, and/or hollow core 240 in preform 200). In embodiments, the preform property is at least the volume of preform 200 (such as the volume of the gas within glass cladding tube 220, glass tubes 230, and/or hollow core 240 in preform 200). In embodiments, the preform property is at least the number of moles of gas within preform 200 (such as the number of moles of gas within glass cladding tube 220, glass tubes 230, and/or hollow core 240 in preform 200). In embodiments, the preform property is at least the temperature within preform 200 (such as the temperature of the gas within glass cladding tube 220, glass tubes 230, and/or hollow core 240 in preform 200). In embodiments the preform property is a combination of one or more of these properties. Adjustment mechanism 305 may be used to measure and adjust the preform property to change the preform property from a first value to a second value.

After the adjustment of the preform property, the effect of such adjustment on the dimension is determined. More specifically, it is determined if the adjustment preform property affected the dimension such that the dimension is now within the predetermined target range. Therefore, after step 130D-2, the measured dimension is again measured (at step 130A) and compared with the predetermined target range (at step 130B). If it is determined that the measured dimension is now within the predetermined target range (step 130C-1), the fiber drawing process continues (step 130D-1). However, if it is again determined that the measured dimension is outside of the predetermined target range (step 130C-2), the preform property is again adjusted. For example, the preform property may be adjusted such that the preform property changes from the second value to a third value. Then the process continues with again measuring the dimension (at step 130A) comparing the effect of such adjustment on the dimension (at step 130B). This process continues until the dimension is within the predetermined target range.

In embodiments, the process steps in FIG. 5 are conducted as hollow core optical fiber 10 is being drawn. Therefore, the measuring of the dimension of step 130A, the comparing of the measured dimension with the predetermined target range of step 130B, and the adjusting of the preform property of step 130D-2 are all preformed as preform 200 is being consumed and drawn into optical fiber 10. Such provides real-time control and adjustment of optical fiber 10 as it is actively being drawn, allowing for greater control over the produced dimensions of the optical fiber and the production of optical fibers with increased dimensional accuracy. Furthermore, the real-time control and adjustment of optical fiber 10 is provided by a feedback control loop in which the dimensions are adjusted and changed based upon the adjusted preform property.

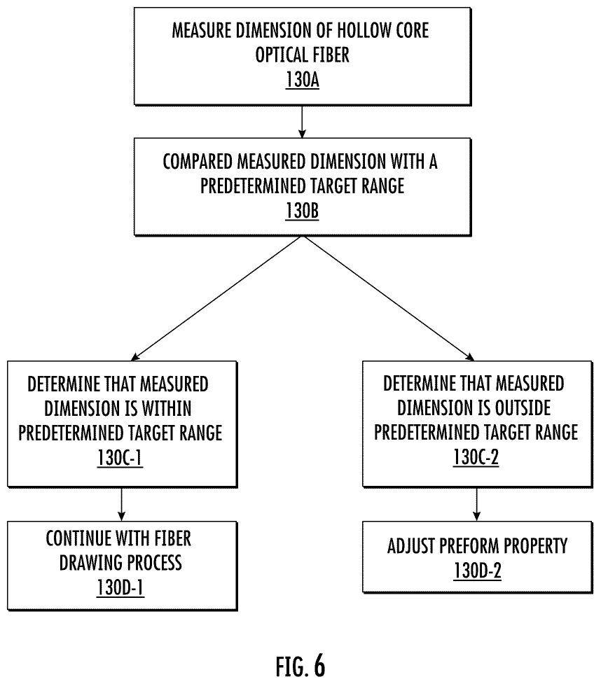

FIG. 5 shows an embodiment in which the feedback control loop is a closed loop. FIG. 6 similarly shows a similar feedback control loop but in which the loop is an open loop. The process steps of FIG. 6 comprise all the same process steps as that of FIG. 5, except in FIG. 6, if it is determined that the measured dimension is outside of the predetermined target value range (step 130C-2), then the one or more preform properties are adjusted (step 130D-2) and the process is complete. A user can then start the process over again at step 130A. It is also noted that the closed loop of FIG. 5, the process steps may be repeated until it is determined that the measured dimension is within the predetermined target range (step 130C-1). In embodiments, the process steps may be automatically and/or continuously repeated until it is determined that the measured dimension is within the predetermined target range.

The process steps in FIGS. 5 and 6 may be performed simultaneously for more than one dimension of hollow core optical fiber 10. For example, with reference to FIG. 5 as an example, in embodiments, a first feedback control loop, following the steps of FIG. 5, is preformed to adjust the inner diameter of structural tubes 30 simultaneously as a second feedback control loop, also following the steps of FIG. 5, is preformed to adjust the diameter of hollow core 40. In this embodiment, the two feedback control loops are preformed simultaneously so that both structural tubes 30 and hollow core 40 are within predetermined target ranges in the drawn optical fiber. In other another exemplary embodiment, a first feedback control loop, following the steps of FIG. 5, is preformed to adjust the inner diameter of inner tubes 34B simultaneously as a second feedback control loop, also following the steps of FIG. 5, is preformed to adjust the inner diameter of second tubes 32B. In this embodiment, the two feedback control loops are preformed simultaneously so that both inner and outer tubes 34B, 32B are within predetermined target ranges in the drawn optical fiber.

In other embodiments, two or more feedback control loops may be performed in succession such that, for example, a second feedback control loop is performed after completion of a first feedback control loop. In other embodiments, the two or more feedback control loops may overlap partially such that, for example, a second feedback control starts after the beginning of a first feedback control but before the end of the first feedback control loop.

As discussed above, the preform property of FIGS. 5 and 6 may be, for example, the pressure, volume, number of moles, and/or temperature of the gas within hollow core optical fiber preform 200. It is noted that during the drawing of hollow core optical fiber preform 200, the top of the preform is sealed and the bottom is effectively sealed as the bottom diameter becomes so small when drawn into fiber 10. Therefore, the interior of preform 200 is effectively a closed container subject to the ideal gas law: PV=nRT, where P is the pressure of the gas, V is the volume of the gas, n is the number of moles of the gas, R is the ideal gas constant, and T is the temperature of the gas. The ideal gas law shows the relationship between temperature, pressure, volume, and number of moles of a gas. In the embodiments disclosed herein, at least one of the pressure, volume, number of moles, and/or temperature of the gas within preform 200 is adjusted (the adjusted preform property in step 130D-2). In embodiments, the pressure and volume of the gas within preform 200 may be increased by increasing the number of moles and/or by increasing the temperature. The number of moles may be increased by adjusting the flow rate of the gas and allowing more gas to flow within the preform. The temperature may be increased by heating the preform.

In one particular embodiment of the steps of FIG. 5, the inner diameter of structural tubes 30 of fiber 10 (the size of capillaries 35) are adjusted based on the pressure of the gas within glass tubes 230 of preform 200. As discussed above, monitor 330 measures the diameter dimensions of structural tubes 30 in step 130A. Then, at step 130B, monitor 330 compares the measured diameter dimension of structural tubes 30 with a predetermined target range. If it is determined that the inner diameter of structural tubes 30 is not within that target range (step 130C-2), the pressure of the gas within glass tubes 320 is adjusted using adjustment mechanism 305 (step 130D-2), which causes the inner diameter of structural tubes 30 to change to a second diameter. Monitor 330 may then measure the second inner diameter of structural tubes 30 (step 130A) and compare the second inner diameter of structural tubes 30 with the predetermined target range (step 130B). If it is again determined that the second inner diameter of structural tubes 30 is not within the predetermined target range (step 130C-2), the pressure within glass tubes 320 is again adjusted (step 130D-2), which causes the inner diameter of structural tubes 30 to change to a third diameter. This process may be repeated again and again until it is determined that the inner diameter of structural tubes 30 is within the predetermined target range (step 130C-1). At that point, the pressure within glass tubes 230 may be held constant and the fiber drawing process continues (step 130D-1).

In embodiments, increasing at least one of the pressure, volume, number of moles, and/or temperature of the gas within preform 200 causes the measured dimension of fiber 10 to be larger. For example, increasing at least one of the pressure, volume, number of moles, and/or temperature of the gas within preform 200 causes the inner diameter of structural tube 30 in fiber 10 to be larger, so that capillaries 35 are also larger.

It is also noted that, in some embodiments, increasing at least one of the pressure, volume, number of moles, and/or temperature of the gas within preform 200 may cause other dimensions to be smaller. For example, increasing at least one of the pressure, volume, number of moles, and/or temperature of the gas within preform 200 causes the inner diameter of structural tubes 30 to be larger but may not have an effect on the outer diameter of structural tubes 30, so that capillaries 35 expand and become larger but the thickness of structural tubes 30 becomes smaller. Therefore, in some embodiments, increasing at least one of the pressure, volume, number of moles, and/or temperature of the gas within preform 200 may cause some dimensions to become smaller, such as a wall thickness (e.g., a wall thickness of structural tubes 30).

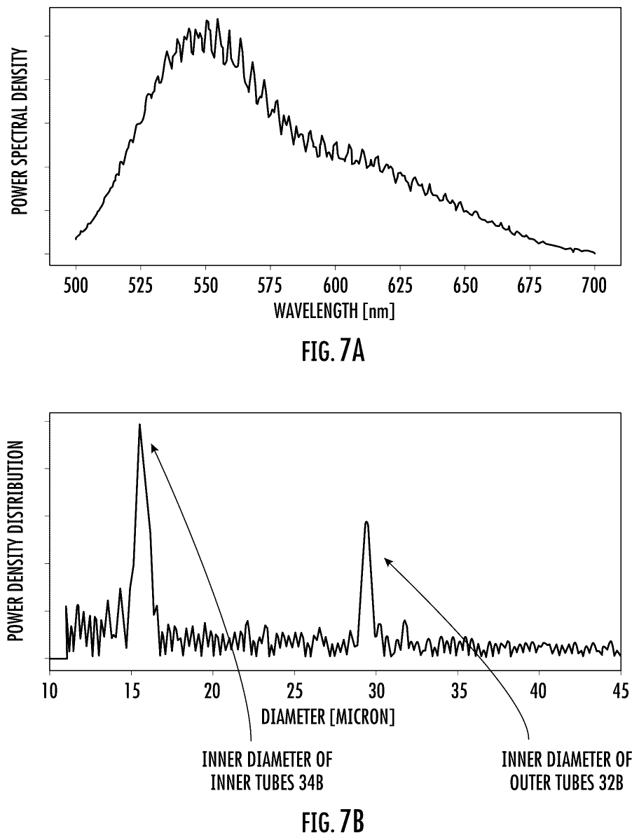

Monitor 330 may measure and adjust the dimension of hollow core optical fiber 10 using any well-known means such as, for example, a spectrometer to obtain an interference spectrum. The spectrometer produces a curve showing power spectral density P as a function of wavelength λ. FIG. 7A shows an exemplary interference spectrum in which the normalized power spectral density P is plotted as function of wavelength λ.

FIG. 7B shows a Fourier transform plot of the exemplary interference spectrum plot of FIG. 7A. The measured dimension (such as the measured diameter dimension from step 130A of FIGS. 5 and 6) is determined from the Fourier transform plot. In particular, the peak(s) of the Fourier transform plot correspond to the measured dimension(s). In the example shown in FIG. 7B, the first main peak corresponds to the inner diameter of inner tubes 34B and the second main peak corresponds to the inner diameter of outer tubes 32B.

The interference spectrum plot (such as the plot shown in FIG. 7A) is converted to a Fourier transform plot (such as the plot shown in FIG. 7B) based upon the relationship between the operating wavelength λ and optical frequency v of a fiber with the speed of light, as shown in Equation 1 below. Based upon this relationship, the power spectral density as a function of wavelength P(λ) can be converted to power spectral density as a function of the optical frequency P(v), as shown in Equation 2.

$$c = λ v , \qquad Equation 1$$

$$P ( v ) = P ( λ = \frac{c}{v} ) , \qquad Equation 2$$

wherein c is the speed of light (m/s), λ is the wavelength of light propagating through the optical fiber (nm), and v is the optical frequency (Hz).

Taking the Fourier transform of power spectral density as a function of the optical frequency P(v) leads to the temporal power density distribution K (Ta) as a function of time delay τ_{d} (sec), as shown in Equation 3:

$$K ( {τ}_{d} ) = ℱ \{ P ( v ) \} , \qquad Equation 3$$

wherein the operator [symbol] represents the Fourier Transform and τ_{d} is the time delay required for the light to propagate through a circumference of the measured capillary (the inner diameter of the structural tube) in the drawn fiber πD_{cap}, as shown by Equation 4:

$${τ}_{d} = \frac{circumference}{c} {n}_{g} = \frac{π {D}_{cap}}{c} {n}_{g} , \qquad Equation 4$$

wherein n_{g} is the group refractive index with n_{g} equal to about 1.45. The temporal power density distribution K can be expressed in terms of D_{cap}, as shown by Equation 5:

$$K ( {D}_{cap} ) = K ( {τ}_{d} = \frac{π {D}_{cap}}{c} {n}_{g} ) . \qquad Equation 5$$

The main peaks in K(D_{cap}) correspond to the capillary inner (D_{cap,inner}) and outer (D_{cap,outer}) diameters of the nested structural tubes.

Other exemplary measurement means to measure the diameter of hollow core optical fiber 10 include, for example, photoacoustic techniques based on the measurement of induced mechanical vibrations, for which the frequency is linked to the capillary dimension, and the use of pulsed X rays coupled with direct radiographic sensors, with potentially several viewing angles taken simultaneously to be able to compute a cross sectional image of the hollow core fiber.

Adjustment mechanism 305 may measure and adjust the preform property of hollow core optical fiber preform 200 using any well-known means such as, for example, standard transducers, pressure controllers, flow controllers, heaters, and/or coolers.

As discussed above, embodiments of the present disclosure are directed to methods of producing hollow core optical fiber such that the fibers have specific size dimensions. Such allows the optical fiber to be tuned to provide anti-resonance for predetermined wavelengths. In some embodiments, the structural tubes of the optical fibers produced herein are specifically sized so that the structural tubes provide anti-resonance for wavelengths of about 1550 nm.

The various illustrative process and process steps disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions and process steps disclosed herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions and process steps disclosed herein can be implemented using software executed by a processor, hardware, firmware, hardwiring, or combinations of any of these. Features implementing functions and process steps may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

According to a first aspect, a method of manufacturing a hollow core optical fiber from a hollow core optical fiber preform, the method comprising measuring a first dimension of the hollow core optical fiber while drawing the hollow core optical fiber from the hollow core optical fiber preform, comparing the measured first dimension with a predetermined target range, and adjusting a first preform property of the hollow core optical fiber preform if the measured first dimension is outside of the predetermined target range while drawing the hollow core optical fiber from the hollow core optical fiber preform.

According to a second aspect, the method of the first aspect, wherein the measured first dimension is a first diameter dimension of the hollow core optical fiber.

According to a third aspect, the method of the second aspect, wherein the hollow core optical fiber comprises an outer cladding and one or more inner structural tubes, and the first diameter dimension is an inner diameter of the one or more structural tubes.

According to a fourth aspect, the method of any one of the first through third aspects, wherein the first preform property is the pressure, volume, number of moles, and/or temperature of a gas within the hollow core optical fiber.

According to a fifth aspect, the method of the fourth aspect, wherein the first preform property is the pressure of the gas within the hollow core optical fiber.

According to a sixth aspect, the method of any one of the first through fifth aspects, wherein the predetermined target range is a range of values.

According to a seventh aspect, the method of any one of the first through fifth aspects, wherein the predetermined target range is a specific value.

According to an eighth aspect, the method of any one of the first through seventh aspects, further comprising continuing with the drawing of the hollow core optical fiber if the measured first dimension is within the predetermined target range.

According to a ninth aspect, the method of any one of the first through eighth aspects, further comprising after adjusting the first preform property of the hollow core optical fiber preform, measuring the first dimension of the hollow core optical fiber a second time while drawing the hollow core optical fiber from the hollow core optical fiber preform, comparing the measured first dimension with a predetermined target range a second time, and adjusting the first preform property of the hollow core optical fiber preform a second time if the measured first dimension is outside of the predetermined target range while drawing the hollow core optical fiber from the hollow core optical fiber preform.

According to a tenth aspect, the method of any one of the first through ninth aspects, further comprising measuring a second dimension of the hollow core optical fiber while drawing the hollow core optical fiber from the hollow core optical fiber preform, comparing the measured second dimension with the predetermined target range, and adjusting a second preform property of the hollow core optical fiber preform if the measured second dimension is outside of the predetermined target range while drawing the hollow core optical fiber from the hollow core optical fiber preform, wherein the measured second dimension is different from the measured first dimension.

According to an eleventh aspect, the method of the tenth aspect, wherein the measured second dimension is a second diameter dimension of the hollow core optical fiber.

According to a twelfth aspect, the method of the eleventh aspect, wherein the hollow core optical fiber comprises an outer cladding, one or more outer structural tubes, and one or more inner nested structural tubes, and the first diameter dimension is an inner diameter of the one or more outer structural tubes and the second diameter dimension is an inner diameter of the one or more inner nested structural tubes.

According to a thirteenth aspect, the method of the eleventh aspect, wherein the hollow core optical fiber comprises an outer cladding, one or more inner structural tubes, and a hollow core, and the first diameter dimension is an inner diameter of the one or more structural tubes and the second diameter dimension is a diameter of the hollow core.

According to a fourteenth aspect, the method of any one of the tenth through thirteenth aspects, wherein the steps of measuring the second dimension, comparing the measured second dimension, and adjusting the second preform property are performed simultaneously as the steps of measuring the first dimension, comparing the measured first dimension, and adjusting the first preform property.

According to fifteenth aspect, the method of any one of the tenth through thirteenth aspects, wherein the steps of measuring the second dimension, comparing the measured second dimension, and adjusting the second preform property are performed in succession after the steps of measuring the first dimension, comparing the measured first dimension, and adjusting the first preform property.

According to a sixteenth aspect, the method of any one of the tenth through sixteenth aspects, wherein the steps of measuring the second dimension, comparing the measured second dimension, and adjusting the second preform property are performed at least partially overlapping in time with the steps of measuring the first dimension, comparing the measured first dimension, and adjusting the first preform property.

According to a seventeenth aspect, the method of any one of the first through sixteenth aspects, further comprising repeating the steps of measuring the first dimension, comparing the measured first dimension, and adjusting the first preform property until determining that the measured first dimension is within the predetermined target range.

According to an eighteenth aspect, the method of the seventeenth aspect, wherein the steps of measuring the first dimension, comparing the measured first dimension, and adjusting the first preform property are automatically repeated until determining that the measured first dimension is within the predetermined target range.

According to a nineteenth aspect, the method of any one of the first through eighteenth aspects, wherein drawing the hollow core optical fiber from the hollow core optical fiber preform comprises applying heat to at least a bottom portion of the optical fiber preform and pulling a root portion of the hollow core optical fiber preform.

According to a twentieth aspect, the method of any one of the first through nineteenth aspects, further comprising measuring the first dimension of the hollow core optical fiber with a spectrometer.

While various embodiments have been described herein, they have been presented by way of example only, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but may be interchanged to meet various needs as would be appreciated by one of skill in the art.

It is to be understood that the phraseology or terminology used herein is for the purpose of description and not of limitation. The breadth and scope of the present disclosure should not be limited by any of the above-described exemplary embodiments but should be defined only in accordance with the following claims and their equivalents.

What is claimed is:

1. A method of manufacturing a hollow core optical fiber from a hollow core optical fiber preform, the method comprising:
measuring a first dimension of the hollow core optical fiber while drawing the hollow core optical fiber from the hollow core optical fiber preform;
comparing the measured first dimension with a predetermined target range; and
adjusting a first preform property of the hollow core optical fiber preform if the measured first dimension is outside of the predetermined target range while drawing the hollow core optical fiber from the hollow core optical fiber preform.

2. The method of claim 1, wherein the measured first dimension is a first diameter dimension of the hollow core optical fiber.

3. The method of claim 2, wherein the hollow core optical fiber comprises an outer cladding and one or more inner structural tubes, and the first diameter dimension is an inner diameter of the one or more structural tubes.

4. The method of claim 1, wherein the first preform property is the pressure, volume, number of moles, and/or temperature of a gas within the hollow core optical fiber.

5. The method of claim 4, wherein the first preform property is the pressure of the gas within the hollow core optical fiber.

6. The method of claim 1, wherein the predetermined target range is a range of values.

7. The method of claim 1, wherein the predetermined target range is a specific value.

8. The method of claim 1, further comprising continuing with the drawing of the hollow core optical fiber if the measured first dimension is within the predetermined target range.

9. The method of claim 1, further comprising after adjusting the first preform property of the hollow core optical fiber preform:
measuring the first dimension of the hollow core optical fiber a second time while drawing the hollow core optical fiber from the hollow core optical fiber preform;
comparing the measured first dimension with a predetermined target range a second time; and
adjusting the first preform property of the hollow core optical fiber preform a second time if the measured first dimension is outside of the predetermined target range while drawing the hollow core optical fiber from the hollow core optical fiber preform.

10. The method of claim 1, further comprising:
measuring a second dimension of the hollow core optical fiber while drawing the hollow core optical fiber from the hollow core optical fiber preform;
comparing the measured second dimension with the predetermined target range; and
adjusting a second preform property of the hollow core optical fiber preform if the measured second dimension is outside of the predetermined target range while drawing the hollow core optical fiber from the hollow core optical fiber preform,
wherein the measured second dimension is different from the measured first dimension.

11. The method of claim 10, wherein the measured second dimension is a second diameter dimension of the hollow core optical fiber.

12. The method of claim 11, wherein the hollow core optical fiber comprises an outer cladding, one or more outer structural tubes, and one or more inner nested structural tubes, and the first diameter dimension is an inner diameter of the one or more outer structural tubes and the second diameter dimension is an inner diameter of the one or more inner nested structural tubes.

13. The method of claim 11, wherein the hollow core optical fiber comprises an outer cladding, one or more inner structural tubes, and a hollow core, and the first diameter dimension is an inner diameter of the one or more structural tubes and the second diameter dimension is a diameter of the hollow core.

14. The method of claim 10, wherein the steps of measuring the second dimension, comparing the measured second dimension, and adjusting the second preform property are performed simultaneously as the steps of measuring the first dimension, comparing the measured first dimension, and adjusting the first preform property.

15. The method of claim 10, wherein the steps of measuring the second dimension, comparing the measured second dimension, and adjusting the second preform property are performed in succession after the steps of measuring the first dimension, comparing the measured first dimension, and adjusting the first preform property.

16. The method of claim 10, wherein the steps of measuring the second dimension, comparing the measured second dimension, and adjusting the second preform property are performed at least partially overlapping in time with the steps of measuring the first dimension, comparing the measured first dimension, and adjusting the first preform property.

17. The method of claim 1, further comprising repeating the steps of measuring the first dimension, comparing the measured first dimension, and adjusting the first preform property until determining that the measured first dimension is within the predetermined target range.

18. The method of claim 17, wherein the steps of measuring the first dimension, comparing the measured first dimension, and adjusting the first preform property are automatically repeated until determining that the measured first dimension is within the predetermined target range.

19. The method of claim 1, wherein drawing the hollow core optical fiber from the hollow core optical fiber preform comprises applying heat to at least a bottom portion of the optical fiber preform and pulling a root portion of the hollow core optical fiber preform.

20. The method of claim 1, further comprising measuring the first dimension of the hollow core optical fiber with a spectrometer.
